(19) United States
(12) Patent Application Publication
(10) Pub. No.: US 2017/0211324 A1
(43) Pub. Date: Jul. 27, 2017

(54) Cordless Roller Shade

(71) Applicant: CALENDAR ENTERPRISES CO., LTD., Chang-Hwa Hsien (TW)

(72) Inventor: Ju-Huai Chen, Chang-Hwa Hsien (TW)

(21) Appl. No.: 15/003,859

(22) Filed: Jan. 22, 2016

(51) Int. Cl. E06B 9/42; A47H 23/01; E06B 9/58

(52) U.S. Cl. CPC E06B 9/42; E06B 9/58; A47H 23/01; E06B 2009/2447

(57) ABSTRACT

A cordless roller shade includes a frame unit, a rolling unit, a shading unit and a plurality of holding devices. The frame unit includes a fixed track, two side brackets and a winding mechanism. The rolling unit includes a roll cloth having an upper end secured to the winding mechanism and a lower end provided with a first tubular portion, and a first weight bar mounted in the first tubular portion. The shading unit includes a shade cloth having an upper end secured to the fixed track and a lower end provided with a second tubular portion, and a second weight bar mounted in the second tubular portion. Each of the holding devices is mounted on the shade cloth. The holding devices hold the rolling unit so that the rolling unit is kept at a straight state when hanging down.

### BACKGROUND OF THE INVENTION

1. Field of the Invention

The present invention relates to a window accessory and, more particularly, to a cordless roller shade mounted on a window or door.

2. Description of the Related Art

A conventional motorized roller shade in accordance with the prior art shown in FIG. 8 comprises a winding mechanism 5 having a shaft 51 and a shade cloth 6 having an upper end secured to the shaft 51 of the winding mechanism 5. When the winding mechanism 5 is operated, the shaft 51 of the winding mechanism 5 is rotated to move the shade cloth 6 upward or downward so as to fold or expand the shade cloth 6. Thus, the shade cloth 6 is expanded and folded by operation of the winding mechanism 5 without needing a pull cord so that the conventional motorized roller shade is operated safely and conveniently. However, when the shade cloth 6 hangs down, there is no support force to limit the two sides of the shade cloth 6 so that the two sides of the shade cloth 6 are easily flexed. Thus, the shade cloth 6 is not expanded in a straight manner when hanging down, thereby decreasing the whole appearance of the conventional motorized roller shade.

### BRIEF SUMMARY OF THE INVENTION

The primary objective of the present invention is to provide a cordless roller shade that is kept at a straight state smoothly when hanging down.

In accordance with the present invention, there is provided a cordless roller shade comprising a frame unit, a rolling unit connected with the frame unit, a shading unit connected with the frame unit, and a plurality of holding devices mounted on the shading unit. The frame unit includes a fixed track, two side brackets mounted on two ends of the fixed track, and a winding mechanism mounted between the two side brackets. The rolling unit includes a roll cloth having an upper end secured to the winding mechanism of the frame unit and a lower end provided with a first tubular portion, and a first weight bar mounted in the first tubular portion of the roll cloth. The roll cloth of the rolling unit is driven and rolled by the winding mechanism of the frame unit to move upward and downward. The lower end of the roll cloth is encircled to form the first tubular portion. The shading unit includes a shade cloth having an upper end secured to the fixed track of the frame unit and a lower end provided with a second tubular portion, and a second weight bar mounted in the second tubular portion of the shade cloth. The lower end of the shade cloth is encircled to form the second tubular portion. Each of the holding devices is mounted on the shade cloth of the shading unit. The holding devices hold the rolling unit when the rolling unit hangs down so that the rolling unit is kept at a straight state when hanging down.

According to the primary advantage of the present invention, the roll cloth of the rolling unit is kept at a straight state smoothly when hanging down by provision of the first weight bar and the holding devices, thereby enhancing the outer appearance of the cordless roller shade.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a cordless roller shade in accordance with the preferred embodiment of the present invention.

FIG. 2 is an exploded perspective view of the cordless roller shade as shown in FIG. 1.

FIG. 3 is an exploded perspective view of one of the holding devices of the cordless roller shade as shown in FIG. 1.

FIG. 4 is a schematic operational view of the cordless roller shade as shown in FIG. 1.

FIG. 5 is a locally enlarged view of the cordless roller shade taken along mark “A” as shown in FIG. 4.

FIG. 6 is a schematic operational view of the cordless roller shade for a window as shown in FIG. 1.

FIG. 7 is another schematic operational view of the cordless roller shade for a window as shown in FIG. 1.

FIG. 8 is a perspective view of a conventional roller shade in accordance with the prior art.

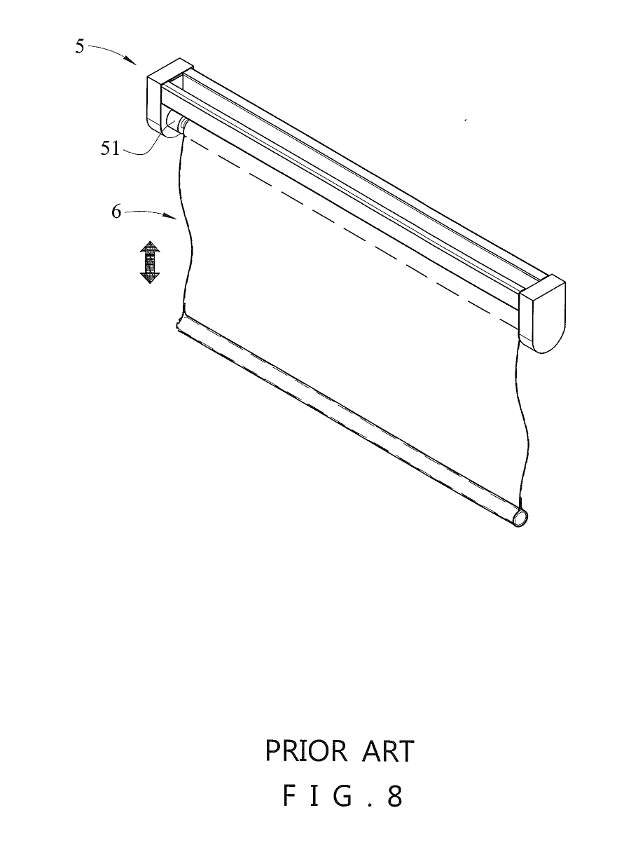

### DETAILED DESCRIPTION OF THE INVENTION

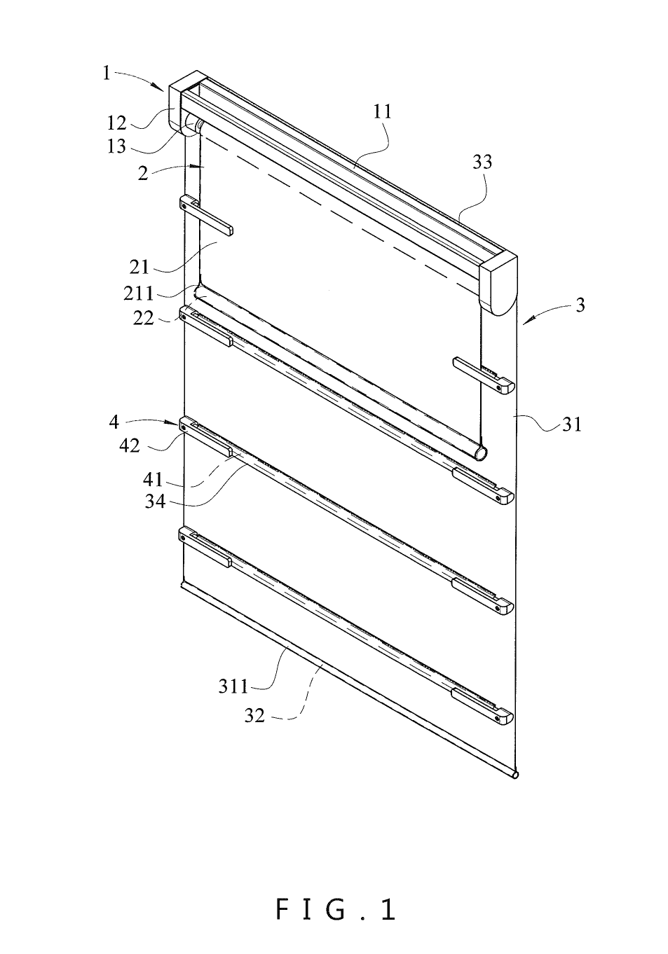

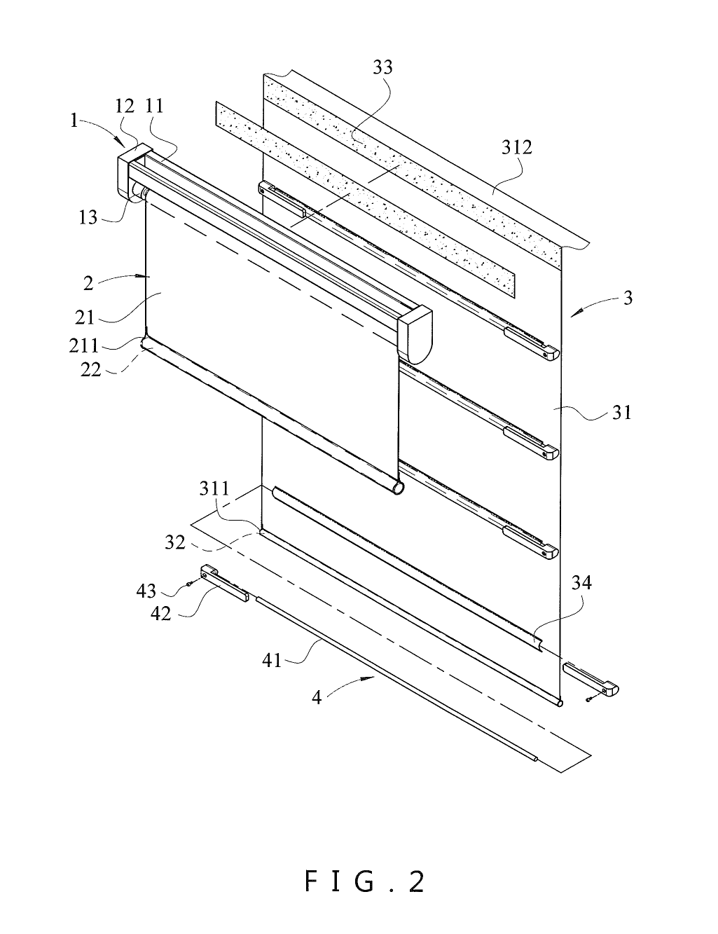

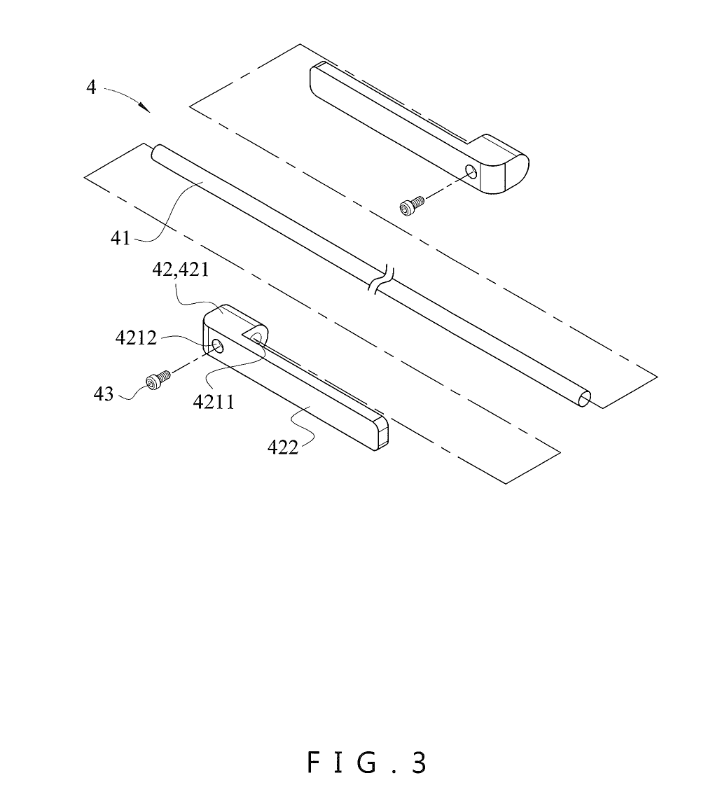

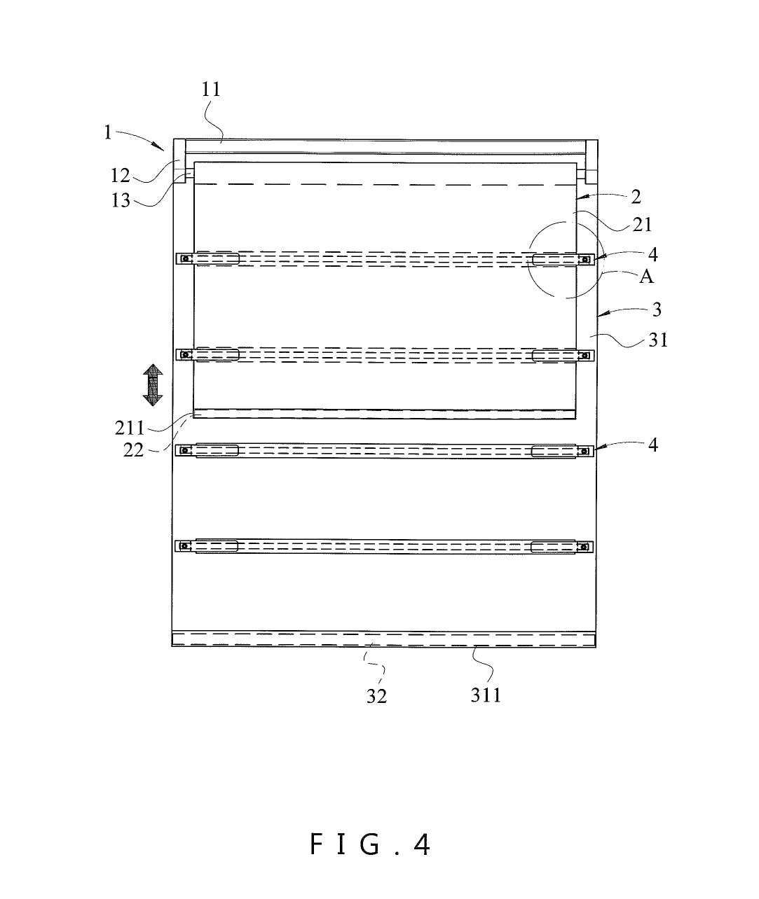

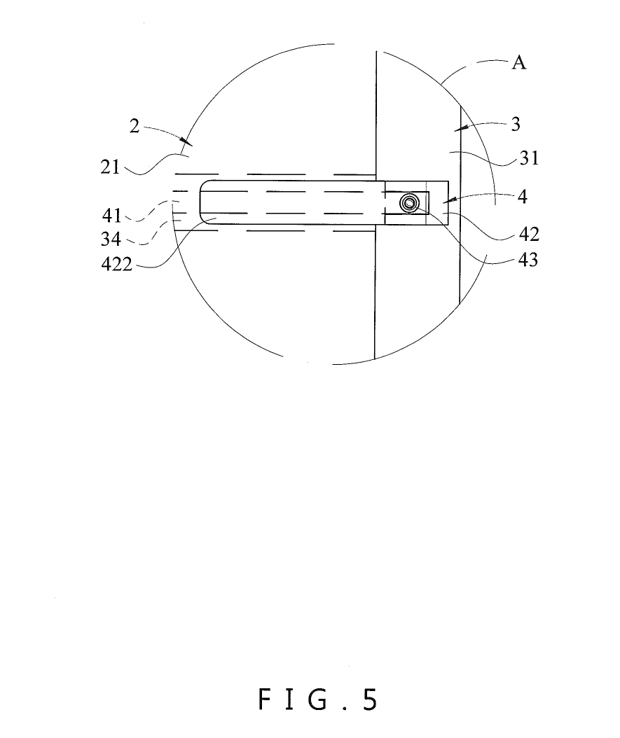

Referring to the drawings and initially to FIGS. 1-5, a cordless roller shade in accordance with the preferred embodiment of the present invention comprises a frame unit 1, a rolling unit 2 connected with the frame unit 1, a shading unit 3 connected with the frame unit 1, and a plurality of holding devices 4 mounted on the shading unit 3.

The frame unit 1 includes a fixed track 11, two side brackets 12 mounted on two ends of the fixed track 11, and a winding mechanism 13 mounted between the two side brackets 12. The frame unit 1 is made of metallic material, such as copper, stainless steel, aluminum, zinc or iron. The fixed track 11 of the frame unit 1 has an elongate shape. Each of the two side brackets 12 is removably mounted on the fixed track 11.

The rolling unit 2 includes a roll cloth 21 having an upper end secured to the winding mechanism 13 of the frame unit 1 and a lower end provided with a first tubular portion 211 by sewing, and a first weight bar 22 mounted in the first tubular portion 211 of the roll cloth 21. The roll cloth 21 of the rolling unit 2 hangs down and is driven and rolled by the winding mechanism 13 of the frame unit 1 to move upward and downward. The lower end of the roll cloth 21 is encircled to form the first tubular portion 211.

The shading unit 3 includes a shade cloth 31 having an upper end secured to the fixed track 11 of the frame unit 1 and a lower end provided with a second tubular portion 311 by sewing, and a second weight bar 32 mounted in the second tubular portion 311 of the shade cloth 31. The shade cloth 31 of the shading unit 3 hangs down. The lower end of the shade cloth 31 is encircled to form the second tubular portion 311.

Each of the holding devices 4 is mounted on the shade cloth 31 of the shading unit 3. The holding devices 4 hold the rolling unit 2 when the rolling unit 2 hangs down so that the rolling unit 2 is kept at a straight state when hanging down.

In the preferred embodiment of the present invention, the cordless roller shade further comprises a connecting module 33 mounted between the upper end of the shade cloth 31 of the shading unit 3 and an upper edge of a rear portion of the fixed track 11 of the frame unit 1 to connect the shade cloth 31 of the shading unit 3 and the fixed track 11 of the frame unit 1, so that the shading unit 3 is removably mounted on the frame unit 1. Preferably, the connecting module 33 includes Velcro. Preferably, the upper end of the shade cloth 31 of the shading unit 3 is provided with an extension 312.

In the preferred embodiment of the present invention, the shade cloth 31 of the shading unit 3 has a front face provided with a plurality of mounting sleeves 34, and the holding devices 4 are mounted in the mounting sleeves 34. Preferably, each of the mounting sleeves 34 is made of cloth material and is sewn on the front face of the shade cloth 31.

Each of the holding devices 4 includes a rod 41 mounted in each of the mounting sleeves 34, two holding blocks 42 mounted on two ends of the rod 41, and two fasteners 43 respectively mounted on the two holding blocks 42 and pressing the rod 41 so that the two holding blocks 42 are affixed to the rod 41. Each of the two holding blocks 42 has a first end provided with a mounting portion 421 and a second end provided with a holding piece 422. The mounting portion 421 of each of the two holding blocks 42 has a side provided with a mounting hole 4211 mounted on the rod 41 and has a front face provided with a screw bore 4212 connected to the mounting hole 4211. The screw bore 4212 of each of the two holding blocks 42 has a stepped shape. The holding piece 422 of each of the two holding blocks 42 extends transversely and abuts the roll cloth 21 of the rolling unit 2 when the roll cloth 21 of the rolling unit 2 hangs down. Each of the two fasteners 43 is a screw which is screwed into the screw bore 4212 of each of the two holding blocks 42 and presses the rod 41.

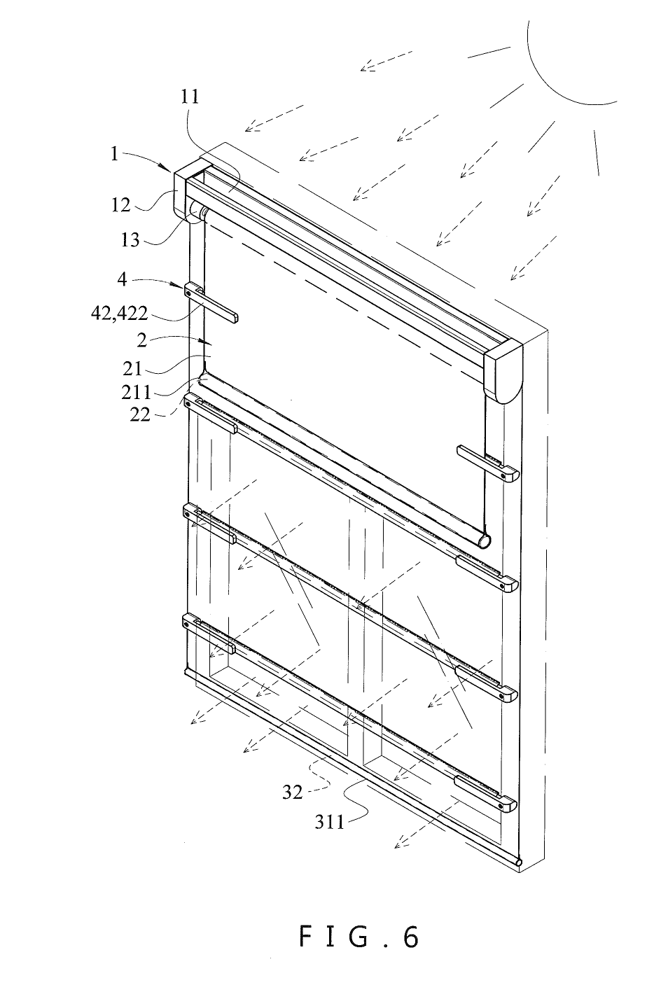

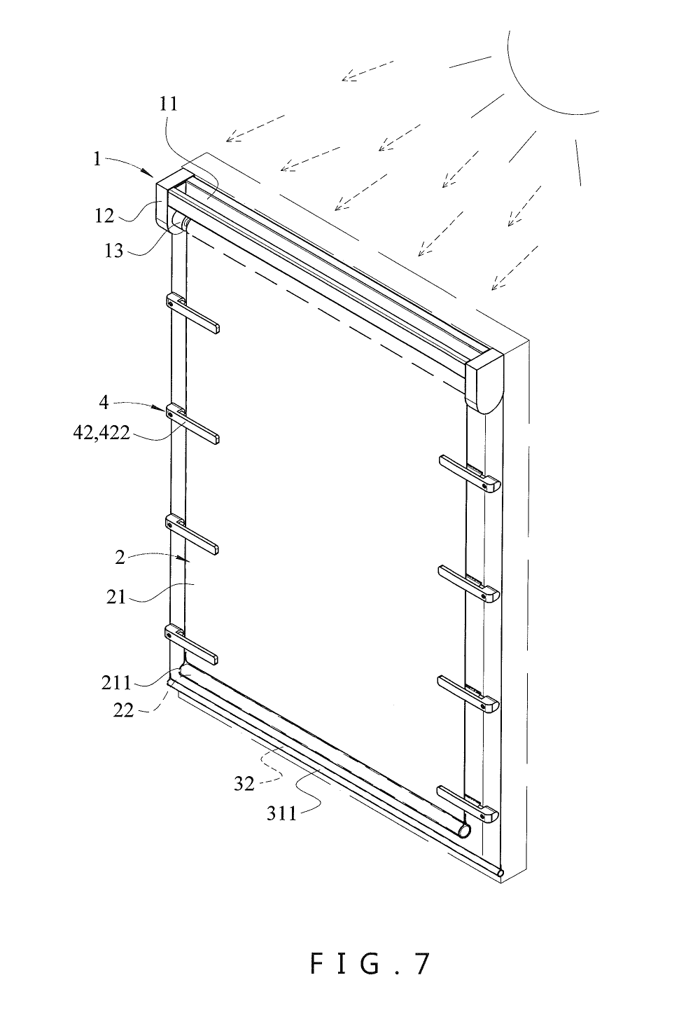

In operation, referring to FIGS. 6 and 7 with reference to FIGS. 1-5, the roll cloth 21 of the rolling unit 2 is driven by the winding mechanism 13 of the frame unit 1 to move upward and downward and is located on any position. In such a manner, the roll cloth 21 of the rolling unit 2 is disposed at a half extending state as shown in FIG. 6 or a fully extending state as shown in FIG. 7. At this time, the first weight bar 22 of the rolling unit 2 provides a downward force (by its gravity) to the roll cloth 21, and the two holding blocks 42 of each of the holding devices 4 hold the two sides of the roll cloth 21, so that the roll cloth 21 of the rolling unit 2 is kept at a straight state when hanging down.

Accordingly, the roll cloth 21 of the rolling unit 2 is kept at a straight state smoothly when hanging down by provision of the first weight bar 22 and the holding devices 4, thereby enhancing the outer appearance of the cordless roller shade.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A cordless roller shade comprising:
a frame unit;
rolling unit connected with the frame unit;
a shading unit connected with the frame unit; and
a plurality of holding devices mounted on the shading unit;
wherein:
the frame unit includes a fixed track, two side brackets mounted on two ends of the fixed track, and a winding mechanism mounted between the two side brackets;
the rolling unit includes a roll cloth having an upper end secured to the winding mechanism of the frame unit and a lower end provided with a first tubular portion, and a first weight bar mounted in the first tubular portion of the roll cloth;
the roll cloth of the rolling unit is driven and rolled by the winding mechanism of the frame unit to move upward and downward;
the lower end of the roll cloth is encircled to form the first tubular portion;
the shading unit includes a shade cloth having an upper end secured to the fixed track of the frame unit and a lower end provided with a second tubular portion, and a second weight bar mounted in the second tubular portion of the shade cloth;
the lower end of the shade cloth is encircled to form the second tubular portion;
each of the holding devices is mounted on the shade cloth of the shading unit; and
the holding devices hold the rolling unit when the rolling unit hangs down so that the rolling unit is kept at a straight state when hanging down.

2. The cordless roller shade of claim 1, wherein the cordless roller shade further comprises a connecting module mounted between the upper end of the shade cloth of the shading unit and an upper edge of a rear portion of the fixed track of the frame unit to connect the shade cloth of the shading unit and the fixed track of the frame unit, so that the shading unit is removably mounted on the frame unit.

3. The cordless roller shade of claim 2, wherein the connecting module includes Velcro.

4. The cordless roller shade of claim 2, wherein the upper end of the shade cloth of the shading unit is provided with an extension.

5. The cordless roller shade of claim 1, wherein the shade cloth of the shading unit has a front face provided with a plurality of mounting sleeves, and the holding devices are mounted in the mounting sleeves.

6. The cordless roller shade of claim 5, wherein each of the mounting sleeves is made of cloth material and is sewn on the front face of the shade cloth.

7. The cordless roller shade of claim 5, wherein each of the holding devices includes a rod mounted in each of the mounting sleeves, two holding blocks mounted on two ends of the rod, and two fasteners respectively mounted on the two holding blocks and pressing the rod so that the two holding blocks are affixed to the rod.

8. The cordless roller shade of claim 7, wherein:
each of the two holding blocks has a first end provided with a mounting portion and a second end provided with a holding piece;
the mounting portion of each of the two holding blocks has a side provided with a mounting hole mounted on the rod and has a front face provided with a screw bore connected to the mounting hole;
the screw bore of each of the two holding blocks has a stepped shape;
the holding piece of each of the two holding blocks extends transversely; and
each of the two fasteners is a screw which is screwed into the screw bore of each of the two holding blocks and presses the rod.
